(19) United States
(12) Patent Application Publication
(10) Pub. No.: US 2025/0392509 A1
(43) Pub. Date: Dec. 25, 2025

(54) Restrictions for Network Device Provisioning

(71) Applicant: Arista Networks, Inc., Santa Clara, CA (US)

(72) Inventor: Eamon Doyle, Dublin (IE)

(21) Appl. No.: 18/754,108

(22) Filed: Jun. 25, 2024

(51) Int. Cl. H04L 41/0806

(52) U.S. Cl. CPC H04L 41/0806

(57) ABSTRACT

A network device may transmit, for a first attempt at device provisioning, messages containing requests that facilitate different types of device provisioning operations such as secure device provisioning operations and non-secure device provisioning operations. Based on receiving a message that contains a reply to one of the requests, the network device may restrict a subsequent attempt at device provisioning to the type of device provisioning operations indicated by the reply.

### BACKGROUND

This relates to network devices, and more particularly, to network devices configured to perform device provisioning.

As an example, when initially connected to a network, a network device may be an un-provisioned network device configured to perform a self-provisioning operation by communicating with a network address assignment server.

### BRIEF DESCRIPTION OF THE DRAWINGS

FIG. 1 is a diagram of an illustrative network in which a network device is configured to communicate with network address assignment server(s) in accordance with some embodiments.

FIG. 2 is a diagram of an illustrative network device in accordance with some embodiments.

FIG. 3 is a diagram of an illustrative network device configured to communicate with network address assignment server(s) using requests for secure and non-secure device provisioning in accordance with some embodiments.

FIG. 4 is a diagram of an illustrative network device configured to maintain an indication to restrict options for device provisioning in accordance with some embodiments.

FIG. 5 is a diagram of an illustrative network device configured to communicate with network address assignment server(s) using a more restricted set of requests for device provisioning in accordance with some embodiments.

FIG. 6 is a diagram of an illustrative network device configured to receive input for overcoming the restrictions to device provisioning in accordance with some embodiments.

FIG. 7 is a flowchart of illustrative operations for performing network device provisioning with restrictions in accordance with some embodiments.

### DETAILED DESCRIPTION

A network can convey network traffic (e.g., in the form of packets, frames, etc.) between hosts or generally between devices in the network. To properly route and forward the network traffic, the network can include a number of network devices configured with networking data such as forwarding decision data, routing decision data, network policy information, etc. Network devices typically require provisioning and the reception of networking data to be operational within the network. To simplify the process of provisioning or configuring a network device for operation, the network device may initiate its own device provisioning operation (sometimes referred to as a self-provisioning operation).

To accommodate for different network and/or server configurations in different deployment scenarios, an un-provisioned network device may be configured to perform self-provisioning in a number of ways, e.g., some of which may involve secure provisioning operations (e.g., device provisioning in compliance with secure provisioning protocol(s)) and some of which may involve non-secure provisioning operations (e.g., device provisioning in compliance with non-secure provisioning protocol(s)). Depending on the configuration of the network, the servers, and/or the sources of bootstrapping data, the network device may selectively restrict options for device provisioning to those determined to be intended for a particular deployment and/or for other reasons.

In configurations described herein as an illustrative example, a network device may transmit messages containing requests, e.g., to a network address assignment server, to perform or generally facilitate device provisioning using either secure or non-secure device provisioning operations. Responsive to a message containing a reply from the network address assignment server indicating that device provisioning via secure provisioning operations is possible (and therefore, desired), the network device may subsequently restrict later attempts of provisioning (should the current attempt at provisioning be unsuccessful), to facilitate or allow device provisioning using (only) secure provisioning operations. Configured in this manner, the network device may further make the provisioning process more secure (e.g., more resistance to spoofing by locking out attempts at non-secure provisioning in deployments in which secure provisioning is desired).

The above-mentioned example in which secure device provisioning is preferred and therefore forms the basis for restricting device provisioning operations is merely illustrative. In general, the network device may preferentially restrict device provisioning to non-secure device provisioning operations, to a specific secure provisioning protocol, to a specific non-secure protocol, or generally to provisioning in a manner determined to be intended for a particular deployment scenario or to satisfy other criteria.

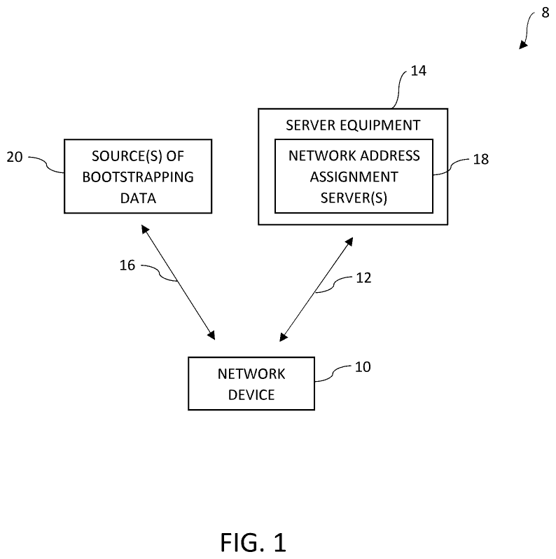

An illustrative networking system in which a network device is configured to perform device self-provisioning is shown in FIG. 1. In particular, FIG. 1 shows an illustrative network 8 which may be of any suitable scope and/or form part of a larger network of any suitable scope. As examples, network 8 may include, be, and/or form part of one or more local segments, one or more local subnets, one or more local area networks (LANs), one or more campus area networks, a wide area network, etc.

Network 8 may include any suitable number of different network devices that connect corresponding host devices of network 8 to one another. At least some of these network devices may be connected by one or more wired technologies or standards such as Ethernet (e.g., using electrical cables and/or fiber optic cables), thereby forming a wired network portion. If desired, network 8 may also include a wireless network portion coupled to the wired network portion. If desired, network 8 may include or be coupled to internet service provider networks (e.g., the Internet) or other public service provider networks, private service provider networks (e.g., multiprotocol label switching (MPLS) networks), and/or other types of networks such as telecommunication service provider networks.

In general, network devices in network 8 can include any number of switches (e.g., single-layer (Layer 2) switches and/or multi-layer (Layer 2 and Layer 3) switches), bridges, routers, gateways, hubs, repeaters, firewalls, wireless access points, network devices serving other networking functions, network devices that include the functionality of two or more of these devices, management devices that control the operation of one or more of these network devices, and/or other types of network devices.

In the example of FIG. 1, the network devices of network 8 include at least network device 10, such as a multi-layer switch or another type of network device (as described above). Network 8 may also include one or more host devices or host equipment such as server equipment 14. Configurations in which network device 10 is an un-provisioned network device (e.g., not a fully provisioned network device) when initially coupled or connected to other elements (e.g., other network devices) of network 8 are sometimes described herein as an illustrative example.

In these configurations, network device 10 may communicate with server equipment 14 via one or more communication paths 12 in an attempt to perform a network device provisioning operation that provisions and configures device 10 itself for operation. In particular, network device 10 may communicate with one or more network address assignment servers 18 implemented on server equipment 14 (e.g., one or more DHCP servers such as server equipment implementing DHCPv4, implementing (stateful or stateless) DHCPv6, implementing a variation of DHCP, implementing a server that is compliant with only some portions of DHCP, and/or implementing other network address assignment protocols) to obtain a network address, and/or general device configuration information, for network device 10.

Additionally, the network address assignment server 18 may provide network device 10 with network addresses (e.g., uniform resource locators (URLs) or web addresses) and/or general indicators or identifiers (e.g., uniform resource identifiers (URIs)) of bootstrapping data source(s) 20. As examples, source(s) 20 may provide networking data, executable files, and/or other bootstrapping data (or redirect information to other source(s) 20). After obtaining its network address, network device 10 may generate one or more network interfaces based on the obtained device configuration information. Network device 10 may then use the interfaces to access bootstrapping data source(s) 20 using the address or identifier provided by server 18 to obtain networking data, executable files, and/or other bootstrapping data (via one or more communication paths 16).

Network device 10 may be considered fully provisioned and ready to perform networking operations (e.g., routing protocols, traffic routing, traffic forwarding, etc.) after successfully executing the obtained executable files, storing the obtained networking data, and/or generally processing the provisioning information, as examples.

In some illustrative configurations, a given bootstrapping source 20 may be a server implemented on server equipment 14 (e.g., a bootstrapping server, a domain name system (DNS) server, etc.). Server 18 and the given source 20 may be implemented on distinct and separate pieces of server computing equipment (e.g., on different processing circuitry or sets of processors, using different storage circuitry accessible by the corresponding processing circuitry, on the same or different server racks, etc.) at server equipment 14 or may be implemented on shared computing equipment (e.g., the same processing circuitry or set of processors, using the same storage circuitry accessible by the processing circuitry, etc.) at server equipment 14. Server 18 and the given source 20 may be implemented at different sites or generally on different network portions of network 8 (e.g., on different local segments) or may be implemented at the same site (e.g., on the same local segment or different local segments). If desired, server 18 or another network address assignment server may also serve as the given source 20.

Communication paths 12 and 16 communicatively coupling network device 10 to server(s) 18 and source(s) 20 may be implemented using network paths of network 8. These network paths may include direct cable connections with or without intervening network devices. In other words, each of paths 12 or 16 may span across portions of network 8 (e.g., one or more network devices therein) to provide the connectivity illustrated in FIG. 1. While shown in FIG. 1 as a single arrow, multiple (different) paths 12 or 16 may communicatively couple network device 10 to server 18 or source(s) 20.

In one illustrative arrangement, network device 10 may lack a direct connection to server equipment 14 and any connection between network device 10 and server equipment 14 may include a router serving as a relay device. In particular, the router may contain a relay agent executing on its processing circuitry to perform relaying of address assignment messages (e.g., DHCP messages), or general network device request and server reply messages as described herein, for network device 10 and server equipment 14 (or more specifically, server 18). This relaying of DHCP messages and/or other types of messages occurs prior to device 10 having or being assigned a network address and thus will differ from normal packet forwarding (e.g., forwarding of packets that identify the network address of device 10). If desired, other routers and/or network devices may also serve as relay devices to relay DHCP messages and/or other messages between device 10 and server equipment 14 (e.g., server 18).

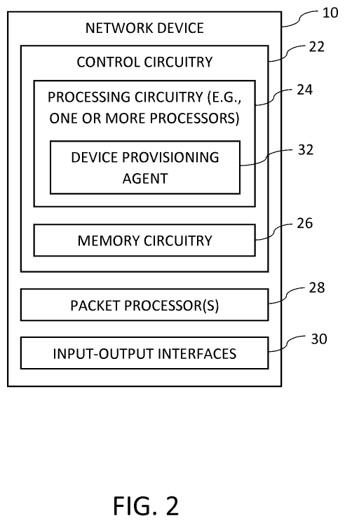

FIG. 2 is a diagram of an illustrative network device such as network device 10 in FIG. 1. In some configurations described herein as an illustrative example, network device 10 may be an un-provisioned multi-layer switch or other type of network device that automatically initiates a device provisioning operation to provision itself after being introduced to network 8 in FIG. 1 (e.g., after being communicatively coupled to components of network 8 such as a router and/or server equipment 14).

As shown in FIG. 2, network device 10 may include control circuitry 22 having processing circuitry 24 and memory circuitry 26, one or more packet processors 28, and input-output interfaces 30 (sometimes referred to as network interfaces) mounted within a housing of network device 10. If desired, the housing may include an exterior cover (e.g., a plastic exterior shell, a metal exterior shell, or an exterior shell formed from other rigid or semi-rigid materials) and/or a supporting substrate that provide structural support and/or protection for the components of network device 10 mounted within and/or on the housing. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 24 may include one or more processors such as central processing units (CPUs), graphics processing units (GPUs), microprocessors, general-purpose processors, host processors, coprocessors, microcontrollers, digital signal processors, programmable logic devices such as field programmable gate array (FPGA) devices, application specific system processors (ASSPs), application specific integrated circuit (ASIC) processors, and/or based on other types of processors.

Processing circuitry 24 may run (e.g., execute) a network device operating system and/or other software/firmware that is stored on memory circuitry 26. Memory circuitry 26 may include one or more non-transitory (tangible) computer-readable storage media that store the operating system software and/or any other software code, sometimes referred to as program instructions, software instructions, software, data, instructions, or code.

As an example, the transmission, reception, and/or processing of various types of communication with device network address assignment server(s) 18 and/or bootstrapping data source(s) 20 described herein may be stored as (software) instructions on the one or more non-transitory computer-readable storage media (e.g., in portion(s) of memory circuitry 26 in network device 10). The corresponding processing circuitry (e.g., one or more processors of processing circuitry 24 in network device 10) may process or execute the respective instructions to perform the transmission, reception, and/or processing various types of communication with device network address assignment server(s) 18 and/or bootstrapping data source(s) 20. Memory circuitry 26 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry. Processing circuitry 24 and (at least the portion of) memory circuitry 26 as described above may sometimes be referred to collectively as control circuitry 22 (e.g., implementing a control plane of network device 10).

As other illustrative operations in addition to operations performed in connection with the communication with server(s) 18 and source(s) 20 (e.g., as part of a device provisioning operation), processing circuitry 24 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 28, may store packet forwarding information, may execute packet processing software, and/or may execute other software instructions that control the functions of network device 10 and the other components therein. Some of these operations such as those associated with routing policy management software, routing protocol agents or processes, routing information base agents, and packet processing software may occur after the device provisioning operation has successfully completed.

Packet processor(s) 28 may be used to implement a data plane or forwarding plane of network device 10. Packet processor(s) 28 may include one or more processors such as programmable logic devices such as field programmable gate array (FPGA) devices, application specific system processors (ASSPs), application specific integrated circuit (ASIC) processors, central processing units (CPUs), graphics processing units (GPUs), microprocessors, general-purpose processors, host processors, coprocessors, microcontrollers, digital signal processors, and/or other types of processors.

Packet processor 28 may receive incoming network traffic via input-output interfaces 30, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 28 (e.g., on content-addressable memory), and/or on a portion of memory circuitry 26. Memory circuitry for packet processor 28 may similarly include volatile memory and/or non-volatile memory.

Input-output interfaces 30 (sometimes referred to herein as network interfaces) may include one or more different types of communication interfaces such as Ethernet interfaces, optical interfaces, network layer (e.g., Internet Protocol (IP) such as IPv4 and/or IPv6) interfaces, wireless interfaces such as Bluetooth interfaces and Wi-Fi interfaces, and/or other communication interfaces for connecting network device 10 to the Internet, a local area network, a wide area network, a mobile network, and/or generally other network device(s), peripheral devices, and computing equipment (e.g., host equipment such as server equipment, client devices, etc.). In illustrative configurations described herein as an example, input-output interfaces 30 may include Ethernet interfaces implemented using and therefore include (Ethernet) ports. In particular, L2 interface circuitry may be coupled to the ports to form Ethernet interfaces with the desired interface configuration. Processing circuitry 24 may further form (e.g., configure) network layer (e.g., IPv4 and/or IPv6) interfaces. The ports may be physically coupled and electrically connected to corresponding mating connectors of external equipment, when received at the ports, and may have different form-factors to accommodate different cables, different modules, different devices, or generally different external equipment.

In configurations in which network device 10 is an initially un-provisioned network device, processing circuitry 24 on network device 10 may execute a device provisioning agent 32 (sometimes referred to herein as a device provisioning process 32) that helps manage and facilitate the device self-provisioning operation described herein after the initially un-provisioned device 10 is supplied with power and is communicatively coupled to a router of network 8 and/or server equipment 14 (e.g., by having a network connection). If desired, this provisioning operation may be initiated automatically by executing agent 32 based on one or more criteria being met. The one or more criteria can include network device 10 being connected to a power source, network device 10 being coupled to one or more elements of network 8, network device 10 lacking an initial configuration, network device 10 receiving one or more user inputs such as the pressing of a button, the providing of a key or other security element, or generally any specified input via a user interface, and/or other suitable provisioning criteria. Configured in this manner, network device 10 may sometimes be referred to herein as a network device configured for secure zero touch provisioning, zero touch provisioning, one touch provisioning, or minimal touch provisioning.

As part of the device provisioning operation, device 10 (e.g., device provisioning agent 32) may obtain the device configuration information such as the network (e.g., IP) address of network device 10. Processing circuitry 24 may use the obtained device configuration information to form one or more network interfaces 30 (e.g., one or more IPv4 or IPv6 interfaces) for device 10. Processing circuitry 24 may obtain an identifier or address of a given bootstrapping data source 20 from a network address assignment server 18. Processing circuitry 24 may subsequently communicate with the given source 20 to obtain bootstrapping data (e.g., executable files, networking data such as routing and forwarding decision data, network policy information, etc., and generally other types of bootstrapping data).

Processing circuitry 24 may execute device provisioning agent 32 by executing software instructions stored on memory circuitry 26. While device provisioning agent 32 is described to perform respective parts of the device provisioning operation for provisioning device 10, this is merely illustrative. Processing circuitry 24 may be organized in any suitable manner (e.g., to execute any other agents or processes instead of or in addition to device provisioning agent 32) to perform each part of the device provisioning operation. Accordingly, processing circuitry 24 may sometimes be described herein to perform the device provisioning operation instead of specifically referring to the one or more agents, processes, and/or kernel executed by processing circuitry 24.

To provide provisioning flexibility and adaptability to different deployment scenarios, an un-provisioned network device such as device 10 may be configured to perform device provisioning based on either secure provisioning protocols or non-secure device provisioning protocols. Secure provisioning protocols may specify operations (to be performed by device 10) by which the ownership of network device 10 is verified (e.g., by the manufacturer) to be a particular owner (i.e., the current owner deploying the network device) and by which the device configuration data and/or other provisioning data received by device 10 during the device self-provisioning operation is determined to be authentic (e.g., is the original intended provisioning data deployed by the owner, is unadulterated, etc.), whereas operations (to be performed by device 10) as specified by non-secure provisioning protocols may lack such verification and authentication mechanisms or corresponding guarantees.

In illustrative configurations described herein as an example, network device 10 may be configured to facilitate device self-provisioning by performing non-secure provisioning operations based on one or more non-secure provisioning protocols (e.g., a zero touch provisioning (ZTP) protocol in compliance with one or more Requests for Comments (RFCs) such as RFC 2131, RFC 2132, RFC 8415, etc., a non-standardized or proprietary ZTP protocol, etc.) and to facilitate device self-provisioning by performing secure provisioning operations based on one or more secure provisioning protocols (e.g., a secure zero touch provisioning (SZTP) protocol in compliance with one or more RFCs such as RFC 8572, RFC 8415, etc., a non-standardized or proprietary SZTP protocol such as the Bootz protocol, etc.).

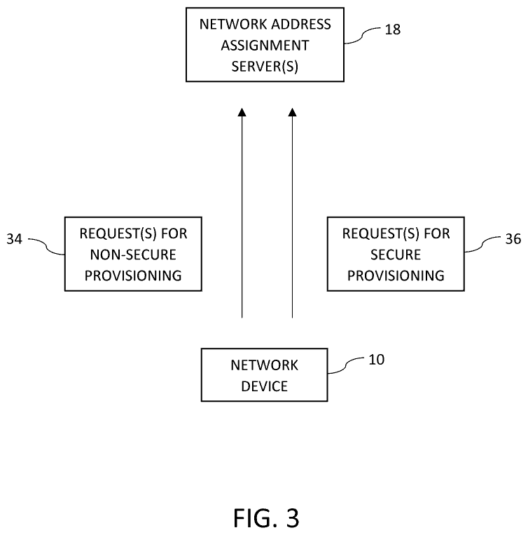

As part of the initial steps of device provisioning, a network device may transmit requests in corresponding request messages destined for one or more network address assignment servers. FIG. 3 is a diagram of an illustrative network device (e.g., device 10 in FIGS. 1 and 2) configured to transmit requests to one or more network address assignment server(s).

In the example of FIG. 3, network device 10 (e.g., processing circuitry 24 when executing software instructions for provisioning process 32) may generate and transmit one or more requests 34 (in corresponding messages) that solicit non-secure provisioning configurations or generally facilitate performance of non-secure device provisioning operations. Processing circuitry 24 may also generate and transmit one or more requests 36 (in corresponding messages) that solicit secure provisioning configurations or generally facilitate performance of secure device provisioning operations. As examples, requests 34 may include a DHCPv4 request, a DHCPv6 stateful request, a DHCPv6 stateless request, and/or other types of requests. Similarly, request 36 may include a DHCPv4 request, a DHCPv6 stateful request, a DHCPv6 stateless request, and/or other types of requests.

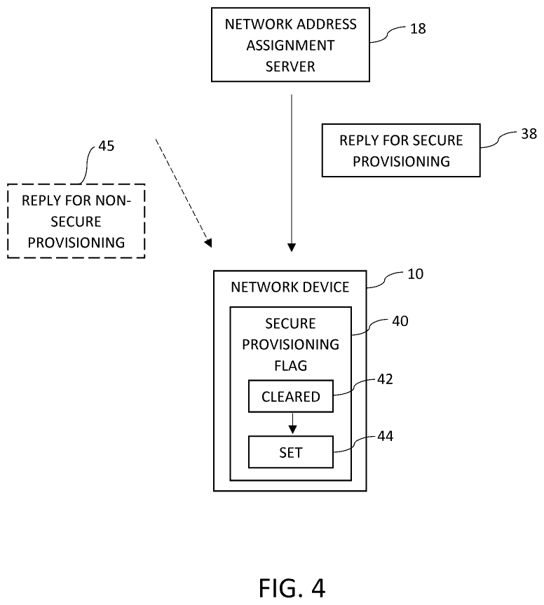

These requests 34 and 36 may be received and processed by one or more network address assignment servers 18. Depending on the configuration of server(s) 18, a given network address assignment server 18 may respond, in response to one of requests 34 or one of requests 36, with a reply in a corresponding reply message. FIG. 4 is a diagram of an illustrative network device (e.g., device 10 in FIGS. 1-3) configured to receive and process a reply from a network address assignment server.

As shown in FIG. 4, network device 10 (e.g., processing circuitry 24) may receive and process reply 38 in a corresponding reply message (e.g., responsive to one of request(s) 36 in FIG. 3) from a network address assignment server 18. In the example of FIG. 4, reply 38 may contain an indication for secure device provisioning (e.g., an indication that secure provisioning operations in accordance with a secure device provisioning protocol should be performed by network device 10). Reply 38 may include the indication for secure device provisioning (e.g., an indication of a secure device provisioning protocol such as a standardized SZTP protocol or a proprietary SZTP protocol) along with one or more corresponding URIs (or URLs) to facilitate secure device provisioning using bootstrap data source(s) 20 identified by the URI(s).

Processing circuitry 24 (e.g., when executing software instructions for provisioning process 32) may perform a device self-provisioning operation based on the information contained in reply 38. As examples, processing circuitry 24 may generate interface(s) based on an assigned address and/or device configuration information in reply 38, may attempt to communicate with a given bootstrap data source 20 over the generated interface(s), may obtain bootstrapping data from the given source 20, and may process the obtained bootstrapping data to provision network device 10 (e.g., by executing executable files, by storing networking data, etc.). In scenarios in which these operations are successfully completed, network device 10 may be fully provisioned and may be operational within the network (e.g., may proceed with normal network operations such as the forwarding or general processing of network traffic).

In scenarios in which at least some of these operations or other device provisioning operations are not successfully completed, this (first) attempt at device provisioning (e.g., in connection with the transmission of requests 34 and 36 in FIG. 3, the reception of reply 38 in FIG. 4, and the provisioning operations based on reply 38 in FIG. 4) may have failed. Given that device 10 has received an indication (e.g., within reply 38) that secure device provisioning is possible and/or preferable in the current network or deployment, network device 10 may be configured to provide a lockout mechanism by which network device 10 may be locked out of performing other types of device provisioning (e.g., performing non-secure device provisioning operations in accordance with one or more non-secure device provisioning protocols such as a standardized ZTP protocol or a proprietary ZTP protocol). By providing this lockout mechanism, the network device may further enhance the security of the device provisioning as network device 10 may have determined that, in a deployment in which secure device provisioning is configured, secure device provisioning is also preferred. This may, among other advantages, prevent attacks in which bootstrap data is spoofed by bad actors.

Illustrative configurations in which the lockout mechanism or general restrictions are placed on device provisioning using an indication of provisioning restriction(s) maintained by network device 10 are sometimes described herein as an example. In particular, network device 10 (e.g., processing circuitry 24) may maintain the indication of provisioning restrictions as a provisioning restriction flag stored on memory circuitry 26. In the example of FIG. 4, the provisioning restriction flag may be a secure provisioning flag 40 (sometimes referred to as a secure-provisioning-only flag or a secure-protocol-only flag) that provides an indication of whether or not subsequent attempts of device provisioning should be restricted to secure device provisioning only (e.g., in accordance with one or more secure device provisioning protocols).

When performing the operations described in connection with FIG. 3 (e.g., sending of requests 34 and 36), secure provisioning flag 40 may be cleared or be in cleared state 42 (e.g., having a binary value of ‘0’) as maintained by processing circuitry 24. After receiving reply 38 (and/or after unsuccessfully provisioning network device 10 based on reply 38), network device 10 (e.g., processing circuitry 24) may set secure provisioning flag 40, updating flag 40 from cleared state 42 to set state 44 (e.g., having a binary value of ‘1’).

The use of secure provisioning flag 40 in the example of FIG. 4 is merely illustrative. If desired, other types of provisioning restriction flags may be maintained and used by network device 10, instead of or in addition to secure provisioning flag 40 to preferentially restrict subsequent attempts at device provisioning to other types of device provisioning (when the corresponding flag(s) are set). The use of one or more flags is merely illustrative. If desired, other (e.g., more complex) indications of provisioning restrictions(s) such as device settings, device operating modes, etc., may be used in addition to or instead of provisioning flags to restrict subsequent attempts at device provisioning to certain types of device provisioning.

While the reception of a single reply 38 in a reply message from server 18 is shown in the example of FIG. 4, this is merely illustrative. In some instances, network device 10 (e.g., processing circuitry 24) may receive multiple replies in corresponding reply messages from one or more network address assignment servers 18, at least one of the multiple replies containing an indication for and therefore facilitating secure device provisioning (e.g., reply 38) and at least one of the multiple replies containing an indication for and therefore facilitating non-secure device provisioning (e.g., reply 45).

As one illustrative example in connection with the above-mentioned instances, processing circuitry 24 may be configured to update flag 40 to set state 44 in response to any of the replies being for secure device provisioning (e.g., regardless of when reply 38 in FIG. 4 is received by device 10 with respect to the other replies, regardless of whether reply 38 is received before or after reply 45).

As another illustrative example in connection with the above-mentioned instances, processing circuitry 24 may be configured to update flag 40 to set state 44 in response to the (only) first reply of the replies received by device 10 being for secure device provisioning (e.g., only when reply 38 in FIG. 4 is the first-received reply). In other words, a subsequent attempt at device provisioning may remain un-restricted with respect to at least secure and non-secure device provisioning when a reply for secure device provisioning (e.g., reply 38 in FIG. 4) is not the first-received reply.

Secure provisioning flag 40 being set may impact (e.g., selectively restrict) any further (subsequent) attempts at network device provisioning. In particular, while secure provisioning flag 40 is set, processing circuitry 24 of device 10 may receive replies for non-secure provisioning such as reply 45 (e.g., responsive to a given request 34), received after processing circuitry 24 has received and processed reply 38 to set flag 40. Processing circuitry 24 may therefore not perform substantive processing of these replies (e.g., reply 45) or more specifically not perform device provisioning using a non-secure provisioning protocol indicated by these replies. In other words, processing circuitry 24 may generally disregard these replies for the purposes of device provisioning (when flag 40 is set). Accordingly, processing circuitry 24 may instead wait for and only process replies indicating secure device provisioning based on a secure device provisioning protocol.

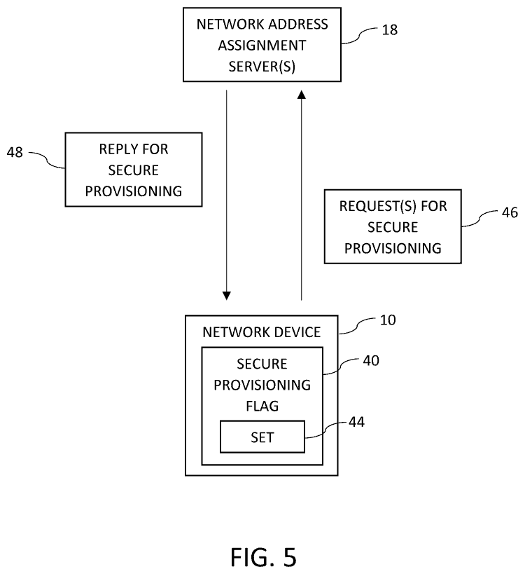

Additionally, while secure provisioning flag 40 is set, processing circuitry 24 of device 10 may also transmit only requests that facilitate secure device provisioning. FIG. 5 is a diagram of an illustrative network device (e.g., device 10 in FIGS. 1-4) configured to perform device provisioning with a provisioning restriction flag that is set. In particular, the device provisioning operation described in FIG. 5 may be a subsequent attempt at device provisioning following one or more initial attempts at self-provisioning that have failed (e.g., after an attempt at device provisioning operation described in connection with FIGS. 3 and 4).

In the example of FIG. 5, network device 10 (e.g., processing circuitry 24) may generate and transmit, based on secure provisioning flag 40 being set, one or more requests 46 in corresponding request messages to network address assignment server(s) 18 that solicit secure provisioning configurations or generally facilitate secure device provisioning operations (without generating or transmitting request(s) for soliciting non-secure provisioning configurations). In other words, responsive to flag 40 being set, processing circuitry 24 may only perform actions to facilitate the performance of secure device provisioning (e.g., in accordance with a single secure device provisioning protocol such as the protocol indicated by reply 38 in FIG. 4 or in accordance with any of multiple secure device provisioning protocols).

Requests 46 may include a DHCPv4 request, a DHCPv6 stateful request, a DHCPv6 stateless request, and/or other types of requests. If desired, requests 46 may be the same combination of requests as or a different combination of requests than requests 36 in FIG. 3.

Network device 10 (e.g., processing circuitry 24) may receive a reply such as reply 48 in a corresponding message from a given server 18 in response to one of the requests 46 and may process reply 48 in a similar manner as described in connection with reply 38 of FIG. 4. In particular, processing circuitry 24 (e.g., when executing software instructions for provisioning process 32) may perform this subsequent attempt at device provisioning (e.g., a second attempt relative to the first attempt in connection with FIGS. 3 and 4) based on the information contained in reply 48. As examples, processing circuitry 24 may generate interface(s) based on an assigned address and/or device configuration information in reply 48, may attempt to communicate with a given bootstrap data source 20 (e.g., identified by a URL in reply 48) over the generated interface(s), may obtain bootstrapping data from the given source 20, and may process the obtained bootstrapping data to provision network device 10 (e.g., by executing executable files, by storing networking data, etc.). In scenarios in which these operations for this subsequent attempt are successfully completed, network device 10 may be fully provisioned and may be operational within the network (e.g., may proceed with normal network operations such as the forwarding or general processing of network traffic).

In scenarios in which at least some of these operations or other device provisioning operations are not successfully completed, this (second) subsequent attempt at device provisioning (e.g., in connection with the transmission of requests 46 in FIG. 5, the reception of reply 48 in FIG. 5, and the provisioning operations based on reply 48 in FIG. 5) may have failed. Accordingly, processing circuitry 24 may perform further (e.g., third, fourth, etc.) attempt(s) of device provisioning by performing actions to facilitate only secure device provisioning based on flag 40 remaining in set state 44. As an example, the operations described in connection with FIG. 5 may be repeated for each of the further attempts.

If desired, processing circuitry 24 may delay each subsequent attempt at device provisioning by an increasing amount of delay (after failure of the prior attempt at device provisioning). For example, processing circuitry 24 may attempt a first instance of device provisioning (e.g., as described in connection with FIGS. 3 and 4); after a first period of time, attempt a second instance of device provisioning (e.g., as described in connection with FIG. 5); after a second period of time greater than the first period of time, attempt a third instance of device provisioning (e.g., as described in connection with FIG. 5), etc.

If desired, processing circuitry 24 may reboot (e.g., power cycle) network device 10 after a longer period of time and/or after a certain number of attempts have failed. While secure provisioning flag 40 may continue to be in a set state across the various attempts at device provisioning, secure provisioning flag 40 may be cleared following the reboot of the network device. In other words, following a reboot, processing circuitry 24 may again attempt a first instance of device provisioning (e.g., as described in connection with FIGS. 3 and 4).

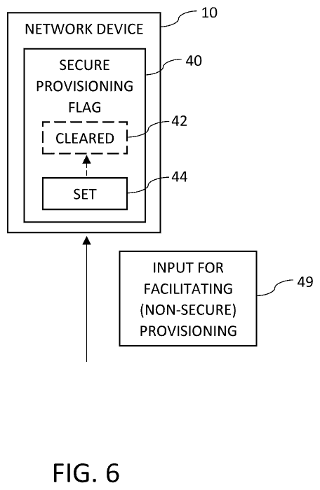

In some instance, the restriction(s) placed on the provisioning of network device 10 (e.g., indicated by secure provisioning flag 40) may be overridden or updated by input received by network device 10 (e.g., between attempts at secure device provisioning and/or prior to a device reboot). FIG. 6 is a diagram of an illustrative network device (e.g., device 10 in FIGS. 1-5) configured to receive input that overrides and/or removes restrictions on device provisioning.

In the example of FIG. 6, network device 10 (e.g., processing circuitry 24) may receive and process input 49 to manage options for any further device provisioning operations. In particular, based on processing input 49, processing circuitry 24 may clear flag 40 (e.g., update flag 40 from set state 44 to cleared state 42) and/or may otherwise override the (secure provisioning) restrictions in place.

As one illustrative example, input 49 may include user input (e.g., a user command received via a user interface, via a command line interface, via an intervening management system, etc.) to update and/or override the state of flag 40 (e.g., from set to cleared) for one or more subsequent attempts at device provisioning. In other words, prior to the processing of this type of input 49, processing circuitry 24 may attempt secure device provisioning using the operations described in connection with FIG. 5. Following the processing of this type of input 49, processing circuitry 24 may attempt secure and non-secure device provisioning using the operations described in connection with FIGS. 3 and 4. If desired, input 48, when processed by processing circuitry 24, may update the state of flag 40 from cleared to set (e.g., skipping the operations described in connection with FIGS. 3 and 4 and proceeding directly to the operation described in connection with FIG. 5).

As another illustrative example, input 49 may include input for facilitating a close-proximity non-secure provisioning operation, which when received and processed by processing circuitry 24 overrides secure provisioning flag 40. In particular, input 49 may be provided by a removable storage device (e.g., a Universal Serial Bus (USB) flash drive or USB key) when physically received at a port or interface of device 10 to initiate the close proximity non-secure provisioning operation, may be provided by external wireless communication equipment that establishes a wireless communication link (e.g., a personal area network communication link such as a Bluetooth communication link) with a wireless interface of device 10 to initiate the close-proximity (non-secure) provisioning operation, and/or may be provided by other external equipment with physical access and/or close proximity to network device 10 to initiate the close-proximity (non-secure) provisioning operation.

Operations as described in connection with FIGS. 3-6, in which secure and non-secure device provisioning are initially attempted and subsequent attempts at device provisioning are restricted to secure device provisioning based on a secure provisioning flag being set, are merely illustrative. More generally, various types of device provisioning may be initially attempted and, responsive to indication(s) that (a subset of) one or more types of device provisioning is preferred, further attempts at device provisioning may be restricted to the one or more types of device provisioning (e.g., based on one or more corresponding types of provisioning restriction flags or other indications of provisioning restrictions being maintained and updated). The various types of device provisioning initially attempted being secure and non-secure device provisioning and the secure device provisioning being preferred on subsequent attempts are merely illustrative examples.

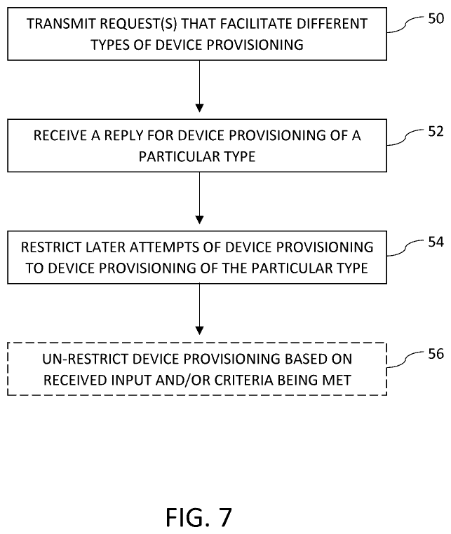

FIG. 7 is a flowchart of illustrative operations for performing network device provisioning. These operations may be performed at one or more processors of processing circuitry 24 in network device 10 (e.g., in FIGS. 1-6). The illustrative operations described in connection with FIG. 7 may generally be performed by processing circuitry 24 executing software instructions stored on memory circuitry 26. If desired, one or more operations described in connection with FIG. 7 may be performed by other dedicated hardware components in device 10. In an illustrative configuration described herein as an example, the operations described in connection with FIG. 7 may be performed by device provisioning agent 32, a kernel executing on processing circuitry 24, or generally by processing circuitry 24 on which they are implemented.

At block 50, processing circuitry on a network device (e.g., processing circuitry 24, when executing device provisioning agent 32 and/or when performing other operations) may transmit requests to facilitate different types of device provisioning. In illustrative configurations described herein as an example, the different types of device provisioning may include secure device provisioning and non-secure device provisioning. In this example, the operations described in connection with FIGS. 3 and 4 may be performed by the processing circuitry when performing the operations at block 50.

At block 52, the processing circuitry may receive a reply for facilitating device provisioning of a particular type in the different types of device provisioning attempted at block 50.

At block 54, the processing circuitry may restrict later (subsequent) attempts of device provisioning to device provisioning of the particular type based on the reply received at block 52 (e.g., based on the reply being conducive to performing the particular type of device provisioning). In particular, the processing circuitry may maintain a provisioning restriction flag or another indication of provisioning restriction. The processing circuitry may set the flag or indication when processing the reply. Responsive to the flag or indication being set, the processing circuitry may restrict subsequent attempts of device provisioning to the particular type of device provisioning. As an example, the processing circuitry may perform the subsequent attempts of device provisioning by sending requests to facilitate only the particular type of device provisioning and not sending requests to facilitate other type(s) of device provisioning (e.g., in contrast to sending requests to facilitate the various types of device provisioning as described in connection with block 50 on a previous or initial attempt).

In illustrative configurations described herein as an example, the particular type of device provisioning to which device provisioning is restricted may be secure device provisioning. In this example, the operations described in connection with FIGS. 4 and 5 may be performed by the processing circuitry when performing the operations at blocks 52 and 54.

In connection with the operations described in connection with blocks 50, 52, and 54, the transmitted requests may be DHCP requests transmitted to one or more address assignment servers (e.g., DHCP servers) and the received replies may be DHCP replies received from the one or more address assignment servers. As an example, requests sent for each type of device provisioning may include at least a DHCPv4 request and a DHCPv6 request.

If desired, at block 56, the processing circuitry may un-restrict device provisioning (e.g., remove or override the restriction(s) set in place at block 54) based on received input and/or other criteria being met. As examples, based on received input, the processing circuitry may allow for and perform a close-proximity device provisioning operation (e.g., using a received removably coupled storage device, using a wireless communication link with an external device, etc.) without the imposed restriction to the particular type of device provisioning.

The methods and operations described above in connection with FIGS. 1-7 may be performed by the components of one or more network devices and/or server or other host equipment using software, firmware, and/or hardware (e.g., dedicated circuitry or hardware). Software code for performing these operations may be stored on one or more non-transitory computer-readable storage media (e.g., tangible computer-readable storage media) on one or more of the components of the network device(s) and/or server or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer-readable storage media may be executed by processing circuitry on one or more of the components of the network device(s) and/or server or other host equipment (e.g., processing circuitry 24 in network device 10).

The foregoing is merely illustrative and various modifications can be made to the described embodiments. The foregoing embodiments may be implemented individually or in any combination.

What is claimed is:

1. An un-provisioned network device configured to perform device self-provisioning, the un-provisioned network device comprising:
memory circuitry; and
processing circuitry coupled to the memory circuitry and configured to:
transmit a plurality of requests for facilitating at least first and second types of device provisioning;
receive a reply for facilitating the first type of device provisioning in response to a given request of the plurality of requests; and
restrict one or more subsequent attempts for device provisioning to the first type of device provisioning based on the received reply.

2. The un-provisioned network device defined in claim 1, wherein the first type of device provisioning comprises secure device provisioning and wherein the second set of device provisioning comprises non-secure device provisioning.

3. The un-provisioned network device defined in claim 2, wherein the processing circuitry is configured to maintain a provisioning restriction flag and is configured to set the provisioning restriction flag in response to the received reply for facilitating the first type of device provisioning.

4. The un-provisioned network device defined in claim 3, wherein the processing circuitry is configured to restrict the one or more subsequent attempts for device provisioning to the first type of device provisioning in response to the provisioning restriction flag being set.

5. The un-provisioned network device defined in claim 4, wherein the processing circuitry is configured to restrict the one or more subsequent attempts for device provisioning to the first type of device provisioning by transmitting additional requests for the one or more subsequent attempts for facilitating the first type of device provisioning and not the second type of device provisioning.

6. The un-provisioned network device defined in claim 1, wherein the plurality of requests are destined for one or more address assignment servers and wherein the reply is received from one of the one or more address assignment servers.

7. The un-provisioned network device defined in claim 6, wherein the plurality of requests comprise one or more Dynamic Host Configuration Protocol (DHCP) requests for facilitating the first type of device provisioning and one or more DHCP requests for facilitating the second type of device provisioning.

8. The un-provisioned network device defined in claim 7, wherein the one or more Dynamic Host Configuration Protocol (DHCP) requests for facilitating the first type of device provisioning comprise a first DHCP version 4 (DHCPv4) request and a first DHCP version 6 (DHCPv6) request and wherein the one or more Dynamic Host Configuration Protocol (DHCP) requests for facilitating the second type of device provisioning comprise a second DHCPv4 request and a second DHCPv6 request.

9. The un-provisioned network device defined in claim 1, wherein the processing circuitry is configured to allow for a close-proximity device provisioning operation without the restriction to the first type of device provisioning.

10. The un-provisioned network device defined in claim 9, wherein the close-proximity device provisioning operation comprises a device provisioning operation performed at least in part by the un-provisioned network device receiving a removably coupled storage device.

11. The un-provisioned network device defined in claim 9, wherein the close-proximity device provisioning operation comprises a device provisioning operation performed at least in part by the un-provisioned network device establishing a wireless communication link with an external device.

12. The un-provisioned network device defined in claim 1, wherein the processing circuitry is configured to perform a reboot of the un-provisioned network device after failing to provision the un-provisioned network device on the one or more subsequent attempts for device provisioning and wherein the restriction to the first type of device provisioning is removed after the reboot of the un-provisioned network device.

13. A network device configured to perform device self-provisioning, the network device comprising:
memory circuitry; and
processing circuitry coupled to the memory circuitry and configured to:
receive a first message containing an indication to perform provisioning using a secure provisioning protocol;
set a flag that restricts provisioning to use of one or more secure provisioning protocols, including the secure provisioning protocol, based on the indication to perform provisioning using the secure provisioning protocol;
receive a second message containing an indication to perform provisioning using a non-secure provisioning protocol; and
disregard the second message based on the flag being set.

14. The network device defined in claim 13, wherein the first message comprises a reply from a network address assignment server, wherein the processing circuitry is configured to transmit a request for facilitating provisioning using a non-secure provisioning protocol and transmit a request for facilitating provisioning using the secure provisioning protocol, and wherein the reply is responsive to the request for facilitating provisioning using the secure provisioning protocol.

15. The network device defined in claim 13, wherein the processing circuitry is configured to transmit one or more additional messages while the flag is set, the one or more additional messages each including an indication to perform provisioning using one of the one or more secure provisioning protocols and wherein the processing circuitry is configured to receive a reply to one of the one or more additional messages and process the reply to perform provisioning based on one of the one or more secure provisioning protocols while the flag is set.

16. The network device defined in claim 13, wherein the processing circuitry is configured to update the set flag to a cleared state based on user input and wherein the processing circuitry is configured to perform, after failing to provision the network device using the first message, an attempt at provisioning that facilitates provisioning using the non-secure provisioning protocol and using the secure provisioning protocol based on the flag being in the cleared state.

17. One or more non-transitory computer-readable storage media comprising computer-executable instructions that, when executed by one or more processors in a network device, cause the one or more processors to:
perform a first attempt at device provisioning by sending a first request that facilitates a first type of device provisioning, by sending a second request to facilitate a second type of device provisioning, and by receiving a reply, responsive to the first request, for the first type of device provisioning; and
in response to failing to provision the network device on the first attempt, restrict a second attempt at device provisioning by sending one or more additional requests that facilitate the first type of device provisioning without sending any requests that facilitate the second type of device provisioning.

18. The one or more non-transitory computer-readable storage media defined in claim 17, wherein the first type of device provisioning comprises secure device provisioning and wherein the second type of device provisioning comprises non-secure device provisioning.

19. The one or more non-transitory computer-readable storage media defined in claim 17 further comprising computer-executable instructions that, when executed by the one or more processors, cause the one or more processors to:
maintain an indication for restricting to the first type of device provisioning; and
update the indication to restrict to the first type of device provisioning based on receiving the reply for the first type of device provisioning.

20. The one or more non-transitory computer-readable storage media defined in claim 17, wherein the first request, the second request, and the one or more additional requests are each a Dynamic Host Configuration System (DHCP) request and wherein the reply is a DHCP reply.
